(19) United States
(12) Patent Application Publication
(10) Pub. No.: US 2003/0148034 A1
(43) Pub. Date: Aug. 7, 2003

(54) Method for forming air permeable film

(75) Inventors: Kunio Sudo, Tokyo (JP); Yoshitaka Matsuki, Tokyo (JP); Eiji Inaba, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kokushin Sangyo K.K., Tokyo (JP)

(21) Appl. No.: 10/060,199

(22) Filed: Feb. 1, 2002

(51) Int. Cl. B05D 1/02

(52) U.S. Cl. 427/421

(57) ABSTRACT

PROBLEM TO BE SOLVED: To provide a method for forming a nonwoven fabric-like continuous film having elasticity and sufficiently air permeability on the surface of a substrate consisting of natural materials or plastic materials made of synthetic resins by solving the problem of single fibers and the problem of vapor of an organic solvent.

SOLUTION: This method for forming the air permeable film consists in forming the air permeable film on the substrate surface by simultaneously spraying a hydrophilic organic solvent solution of linear polyurethane and water to the substrate surface and depositing and solidifying the polyurethane resin on the substrate surface.

### TECHNICAL FIELD

This invention relates to a novel method for forming a film, and more specifically to a method for forming a nonwoven-fabric-like continuous film, which has elasticity and sufficient air permeability, on a surface of a substrate such as a plastic material made, for example, of a natural or synthetic resin.

### BACKGROUND ART

Conventionally, a number of elastic foams such as expanded polyurethane are known, and have been widely used as cushioning foams and the like. Without any further treatment or processing, these foams have micro-roughness on their surfaces, are very inferior in touch feeling and external appearance, and are also poor in surface physical strength. It has, therefore, been a common practice to cover the surfaces of these foams with woven fabrics or nonwoven fabrics or to form continuous films on the surfaces of these foams with synthetic-resin-based coating formulations or the like.

However, a foam to be covered usually has a complex surface structure. It is, therefore, very cumbersome to cover the foam with a woven fabric or nonwoven fabric, resulting in a high manufacturing cost. Moreover, the foam and the film are heterogeneous so that the film cannot conform to deformations of the foam and a variety of inconveniences arise. On the other hand, the use of a synthetic-resin-based coating formulation especially in the case of a foam of a high expansion ratio leads to penetration of the coating formulation into the texture of the foam instead of remaining on the surface of the foam. This results not only in wasting of the coating formulation but also in lowering of the function of the foam. In addition, the thus-formed film is poor in touch feeling, and is low in air permeability. The foam coated as described above, therefore, has an extremely low value as a commercial product. As a method for solving such drawbacks as described above, it is also known to spray a solution of a polyurethane resin onto a surface of a substrate to form a film (JP-B-57056385).

This method can practically solve the above-described drawbacks of the conventional art. It is, however, accompanied by a problem that upon spraying a solution of a polyurethane, clogging takes place in nozzles and the work has to be discontinued, because short staple fibers of small diameter are dispersed in the solution of the polyurethane. According to this method, a film is formed by causing a volatile organic solvent to evaporate. As a result, a great deal of vapor of the solvent is produced, thereby developing many problems in connection with treatment of the evaporated vapor of the solvent. This results in a still further problem that the product so obtained is costly.

An object of the present invention is, therefore, to solve the problem of short staple fibers and the problem of vapor of an organic solvent and to provide a method for forming a nonwoven-fabric-like continuous film, which has elasticity and sufficient air permeability, on a surface of a substrate such as a plastic material made, for example, of a natural or synthetic resin.

### DISCLOSURE OF THE INVENTION

The above-described object can be achieved by the present invention to be described hereinafter. Specifically, the present invention provides a method for forming an air permeable film on a surface of a substrate, which comprises concurrently spraying water and a solution of a linear polyurethane in a hydrophilic organic solvent against the surface of the substrate such that the polyurethane resin is caused to separate and solidify on the surface of the substrate.

According to the present invention, the concurrent spraying of the water and the solution of the linear polyurethane in the hydrophilic organic solvent against the surface of the substrate to be coated causes mixing of the polyurethane solution with the water on the surface of the substrate. As a result, the polyurethane in the solution gels and separates, and a porous film is formed on the surface of the substrate. Subsequent to the separation of the polyurethane resin, the organic solvent is mixed with the water, is allowed to separate from the thus-formed film, and is collected and recovered. A large majority of the organic solvent employed can, therefore, be reused without vaporization into air. Further, no nozzle clogging occurs in the present invention because it is unnecessary to use short staple fibers.

### BRIEF DESCRIPTION OF THE DRAWINGS

FIG. 1 is a view schematically illustrating the method of the present invention.

### BEST MODES FOR CARRYING OUT THE INVENTION

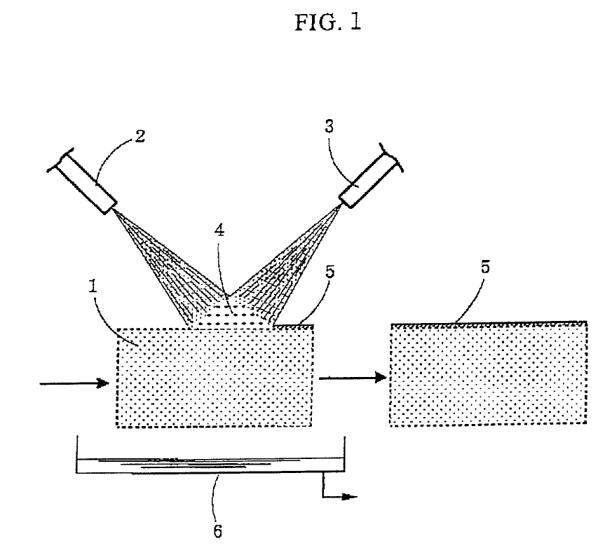

The principle of the present invention will be described with reference to the drawing. The view of FIG. 1 schematically illustrates the method of the present invention. A substrate mounted on a belt conveyor (not shown), for example, a polyurethane foam 1 which has been cut and formed into a predetermined shape is travelling at a constant speed in a direction of arrows. From a nozzle 2 of a spray gun arranged at a predetermined position, a solution of polyurethane in a hydrophilic organic solvent is sprayed against a surface of the foam 1. On the other hand, water is sprayed from another nozzle 3. A mist of the organic solvent solution and that of the water are, therefore, sprayed against and mixed over substantially the same area on the foam 1.

Both of the mists are mixed together in a region 4. At this time, the solvent of the polyurethane solution, for its hydrophilicity, absorbs the atomized and mixed water so that the solubility of the polyurethane is reduced. Accordingly, the polyurethane is caused to gel and separate, is formed into small-diameter fibers under a spray pressure, and is sprayed to deposit on the surface of the foam. The polyurethane covers micro-roughness on the surface of the foam, so that an air permeable film 5 of a predetermined thickness is formed. At this time, the organic solvent which has formed the polyurethane solution is mixed with the water, is separated from the polyurethane film, and is then collected via a mist/drip pan 6. The organic solvent may then be distilled for reuse. The mixed solvent collected by the above-described procedure contains water and is less susceptible to absorption in the foam 1. This makes it possible to minimize vapor of the organic solvent during drying of the coated substrate to be obtained eventually. Production of vapor of the organic solvent in the working environment is therefore very small.

It is to be noted that the method illustrated in FIG. 1 shows only an example of the method according to the present invention. It is possible to form an air permeable film over all the surfaces of a rectangular parallelepiped by arranging plural pairs of spray guns, which are of the same type as the spray guns 2,3, respectively, and subsequent to completion of coating of one of the surfaces of the rectangular parallelepiped 1, automatically changing the nozzle-facing surface of the rectangular parallelepiped. Therefore, the method of the present invention can easily form a seamless film over some or all of surfaces of a substrate the shape of which is not limited to a rectangular parallelepiped but can be chosen as desired.

The substrate to which the method of the present invention is applicable can be any substrate. It is, however, foams of polyurethane, polystyrene, polyethylene, polyvinyl chloride or the like that the method of the present invention can exhibit the best effect. Of these, those having high expansion ratios, those having elasticity, those having air permeability, and like foams are particularly preferred. These foams can each be in a sheet form, a block form, a ball form, a cushion form, or any other form. Without any further treatment or processing, each of these foams generally has a rough surface texture and inferior physical strength. It is, therefore, possible to form on the surface of such a substrate a protective and/or decorative film having toughness, a fine texture, good touch feeling, certain degrees of waterproofness and air permeability.

The principal component of a coating material for use in the present invention is a linear polyurethane resin soluble in a hydrophilic organic solvent. Concerning the polyurethane solution, its resin concentration may range from about 1 to 50 wt. %, preferably from about 5 to 30 wt. %, and its viscosity may range from about 50 to 500,000 cps (20° C.) Beyond the lower limits of these ranges, the sprayed solution undesirably tends to become fine droplets. Beyond the upper limits, on the other hand, the spraying becomes difficult. It is, however, to be noted that these ranges are not absolutely critical in the present invention and may vary depending on other conditions. No particular limitation is imposed on the polyurethane resin for use in the present invention, and any polyurethane can be used insofar as it is employed in diverse coating formulations or synthetic leathers or for various other applications. Preferred examples are polyurethane solutions marketed under the trade name of “RESAMINE”, specifically “RESAMINE ME-823LP” which is a polyester-type polyurethane solution [concentration: about 30 wt. %, viscosity: 500 to 900 dP·s/20° C., solvent composition (weight ratio): MEK/DMF=60/40].

The solvent employed in the polyurethane solution is a hydrophilic solvent. Examples of preferred solvents can include lower alcohols such as ethanol and isopropanol, ketones such as acetone and methyl ethyl ketone, ethers such as dioxane and tetrahydrofuran, dimethylformamide, dimethylsulfoxide, and mixtures thereof, and further, their mixtures with hydrophobic organic solvents such as hydrocarbons such as toluene, Trichlene and Perclene or esters such as ethyl acetate and butyl acetate. When a mixed organic solvent is used, it is preferred that a hydrophilic organic solvent amounts to at least 30 wt. % of the mixed organic solvent. Particularly preferred hydrophilic organic solvents are solvents each of which contains methyl ethyl ketone and/or dimethylformamide.

As equipment for spraying the polyurethane solution and water, conventionally-known spray guns can be used as are. Their spray pressure varies depending on the properties of a solution to be used. In general, however, a pressure of from 2 to 8 atm is preferred. The distance between each spray gun and the surface of the substrate may generally range from about 20 to 50 cm although it also varies depending on the properties of a solution to be used and the manner of use of the equipment. Various conditions such as those mentioned above are each affected by the remaining conditions. It is, therefore, impossible to determine all the conditions in a wholesale manner. Based on experiments common to those skilled in the art, however, conditions can be chosen as needed and can be used in combination. Further, good results can be obtained by controlling the temperature at about 20 to 40° C. during operation by the method of the present invention. An unduly low temperature during the operation is not preferred because the viscosity of the solution becomes too high, while an excessively high temperature during the operation is not preferred because the solvent is susceptible to evaporation.

It is also possible to form a film with properties modified or corrected as needed by incorporating one or more of colorants such as dyes or pigments, organic additives such as PVC, flame retardants, plasticizers, antistatic agents, water repellents, and various other known additives as desired in a polyurethane resin solution to be used in the present invention.

According to the method of the present invention as described above, an air permeable film which is excellent in substantial feeling, is good in touch feeling and is micro-porous can be readily formed on a surface of an article, said surface being coarse in texture, for example, on a surface of a molded or otherwise formed plastic product. No matter how complex the surface of a substrate, such a film can be formed in conformity with the configurations of the surface and moreover, in firm adhesion with the surface. Even if the substrate is elastic, the film is equipped with elasticity and toughness sufficient to permit fully conforming with deformations of the elastic substrate during its use. These unique properties are attributed to the use of the linear polyurethane solution as a coating material and also to the manner of its use such that instead of using it merely as a conventional coating formulation, it is sprayed concurrently with water, the polyurethane is caused to gel and separate in the form of fibers on or in the vicinity of the surface of the substrate and the fibers are then allowed to pile up and adhere on the surface of the substrate to form a nonwoven-fabric-like film.

### EXAMPLES

The present invention will next be described specifically on the basis of Examples and a Comparative Examples, in which the designations of “parts” or “part” and “%” are all on a weight basis.

### Example 1

“RESAMINE ME-823LP” [concentration: about 30 wt. %, viscosity: 500 to 900 dP·s/20° C., solvent composition (weight ratio): MEK/DMF=60/40] was diluted with a 1:1 mixed solvent of methyl ethyl ketone and isopropyl alcohol to provide a 20% solution. To 100 parts of the solution, 1 part of a black pigment, 3 parts of a flame retardant and 1 part of water repellant were added, followed by the stirring into a homogeneous mixture as a black polyurethane solution. The thus-obtained solution was charged into high-pressure spray guns. Into spray guns of the same type, on the other hand, water was charged.

The polyurethane spray guns and water spray guns are arranged parallel in 6 pairs in total, and at a surrounding temperature of from about 30 to 35° C., the polyurethane solution and the water were concurrently sprayed at a distance of about 40 cm against the same area on one of surfaces of a rectangular parallelepiped made of an expanded polyurethane the expansion ratio of which was 100:1. Subsequent to completion of the spraying of the one surface, the rectangular parallelepiped was moved, and the polyurethane solution and the water were sprayed onto another one of the surfaces. This was repeated successively such that a film of about 0.3 mm in thickness was formed over all the surfaces of the rectangular parallelepiped. After the completion of the film over all the surfaces, water was sprayed against all the surfaces to wash off any remaining solvent, and drying was then conducted to obtain a foam covered with a black film. During the drying, substantially no vapor of organic solvent was given off.

The film was an absolutely seamless film. The thus-formed film was in the form of a matted nonwoven fabric of fine texture. Under a microscope, a number of small-diameter fibers were observed in a form piled up at random with a number of micro-pores formed therebetween. When the rectangular parallelepiped was compressed, the film fully conformed to deformations of the rectangular parallelepiped. In addition, its surface was very tough. In the above method, a waste solvent pan was arranged underneath the rectangular parallelepiped, and the water-containing organic solvent collected in the pan was recovered and subjected to fractional distillation to permit reuse.

### Example 2

The method of Example 1 was repeated by using a microphone cover, a helmet cushioning material, a headphone ear pad, a vermilion inkpad, a stamp pad and a sweatshirt/sweatpants cloth and also changing the pigment. As a result, it was possible to form an air permeable and tough film of good touch feeling on each of the substrates.

### INDUSTRIAL APPLICABILITY

According to the present invention, a nonwoven-fabric-like continuous film having elasticity and sufficient air permeability can be formed on a surface of a substrate such as a plastic material made of a natural or synthetic resin. Upon its formation, it is possible to avoid a problem associated with vaporization of a solvent.

1. A method for forming an air permeable film on a surface of a substrate, which comprises concurrently spraying water and a solution of a linear polyurethane in a hydrophilic organic solvent against said surface of said substrate such that said polyurethane resin is caused to separate and solidify on said surface of said substrate.

2. A method according to claim 1, wherein said hydrophilic organic solvent is a solvent comprising methyl ethyl ketone and/or dimethylformamide.
